(19) United States
(12) Patent Application Publication
(10) Pub. No.: US 2005/0252343 A1
(43) Pub. Date: Nov. 17, 2005

(54) Arthritis sufferers multi purpose beverage container opener/sealer with printable surface

(76) Inventor: Donald B. Turner, Baxter Springs, KS (US)

Correspondence Address: Donald B. Turner, 908 E. 17th Street Place, Baxter Springs, KS, 66713, US

(21) Appl. No.: 11/128,296

(22) Filed: May 9, 2005

Related U.S. Application Data
(60) Provisional application No. 60/570,777, filed on May 14, 2004.

(51) Int. Cl. B67B 7/44

(52) U.S. Cl. 81/3.09

(57) ABSTRACT

A multi-purpose beverage container opener/sealer which enables users to open and seal twist-off caps and to open both stay-on can tabs; and crimped-on bottle caps with minimal effort. The tool is rigid and injection molded with the twist-off cap opener/sealer at one end and the stay-on can tab and crimped-on bottle cap opener at the opposite and opposing end. The twist-off opener/sealer is self locating by means of beveling and counter sinking and clasps twist off caps by a series of molded, vertically aligned ribs which is located at the end of the tool with the largest radius. At the opposite end of the largest radius is the stay-on can tab and crimped on bottle closure opener. The stay-on can tab opener is a molded slot in the smaller radius opposite the largest radius. The crimped-on closure opener is a recessed loop molded into the lower surface, near the end of the smaller radius with diameter through. The elongated, planar closure opener is ergonomically correct in form in that its narrowing handle fits the true form of the full palm of the hand and is of sufficient length to act as a force multiplier in both the vertical and horizontal planes which is ideally and specifically suited for users with minimal hand and finger strength, particularly arthritis sufferers.

### CROSS REFERENCE TO RELATED APPLICATIONS

Provisional Patent No. 60/570,777

### SEQUENCE LISTINGS

Not applicable.

### STATEMENT OF FEDERALLY SPONSORED RESEARCH/DEVELOPMENT

Not Applicable

### REFERENCE TO A “SEQUENCE LISTINGS”

Not Applicable

### BACKGROUND OF THE INVENTION

1. Field of the Invention

This invention relates to the field of beverage container closure openers but specifically to beverage can stay-on tab closure openers, crimped-on bottle closure openers and twist-off bottle closure openers.

2. Discription of the Prior Art

Beverage container openers have been manufactured for decades and in a multitude of designs and materials. The first beverage container openers were probably the all-metal V-shaped piercing tools and pry-type openers. However, the V-shaped piercing opener has largely been abandoned but the pry-type opener is still a necessary tool because imported beer bottles still primarily utilize a crimped-on cap that can not be twisted off with the bare hand, thus requiring the pry-type opener.

Domestic beer bottles also utilize a crimped-on cap but most can be twisted-off, albeit discomforting after twisting-off several and so the pry-type opener is still a worthwhile and convenient tool. The largest area of change in beverage container closures has been primarily in two designs. The pull-tab beverage can closure which was the dominant type of closure on beverage cans prior to 1979 and twist-off beverage bottle closures. The pull tab beverage can closure design was used for many years but since it detached it was often discarded on the ground becoming refuge and was somewhat dangerous having a sharp leading edge. In the early 1980's these beverage can closures were redesigned and became the tab-top or commonly referred to “stay-on tab” beverage can closures because after opening the scored closure they remain attached to the beverage can, thus solving the refuse problem and are much less dangerous, particularly to children. This type beverage can closure is still the dominate design on beverage cans even today. The other major beverage container closure change has been the twist-off bottle closure or cap. These plastic serrated caps are found on plastic bottles of varying sizes and are resealable. The outside diameters of these “caps” are approximately the same size even though the container volumes vary widely, from 2-liters down to 8 ounces.

Even though new and improved designs have been made in beverage container closures they still pose special problems to those afflicted with arthritis. It is estimated that twenty-five million Americans suffer from arthritis and sadly there is no known cure. Demographers now suggest this number will increase greatly, primarily because the general population is living longer. Unfortunately, until this present invention, little or no sufficient design work has been done to improve beverage container closure openers for those afflicted with this disabling disease. U.S. Pat. No. 6,105,468 (to Fohrman and Hess) and U.S. Pat. No. 4,967,622 (to Phillips) are both clever designs however, the former is not designed to open the crimped-on pry-type closures of imported beer bottles and the latter by their own description employs the user's fingers, having the twist-off closure engagement area centrally located minimizes the advantage of leverage relying on finger and hand strength, clearly limiting it's use to healthy individuals. The present invention addresses these inadequacies by providing users with a lightweight and ergonomically correct beverage container closure opener, which maximizes leverage and minimizes the necessary finger strength and movement required for opening beverage container closures.

### BRIEF SUMMARY OF THE INVENTION

This invention relates primarily to a beverage container closure openers, specifically opening tab-top beverage cans, crimped-on bottle closures (both pry-off and twist-off types), opening and resealing plastic twist-off bottle closures and is particularly well suited for arthritis sufferers. This beverage container closure opener is primarily injection molded with no moving parts, being substantially elongated, planar and somewhat narrowing. This embodiment has two primary radiuses, the largest with a diameter through, fashioned for the engagement of plastic twist-off caps. The twist-off closure engagement area has three different and distinct inside diameters. The largest inside diameter beginning at the lower surface of the diameter through, being a twist-off closure locating aid which enables users to quickly locate the twist-off closure by means of a bevel or inward slanting angle. The locating aid is attached and integral to the twist-off closure slide, which properly positions and encourages the twist-off closure into the twist-off closure engagement ribs. The twist-off closure slide forms the second smallest inside diameter of the largest diameter through at the end of the largest radius. Attached and integral to the twist-off closure slide is the twist-off closure engagement ribs, which are a series of inward projected, vertically aligned ribs, which make contact with the closure. These vertically aligned ribs are evenly spaced and will open the twist-off closure when the closure opener is rotated counter clockwise. The twist-off closure engagement ribs are the smallest of the three different and distinct inside diameters and extend to the upper surface of the largest diameter through. Each of the three different and distinct inside diameters are attached and integral to the largest diameter through and all form parts of the cylindrical interior wall of the twist-off closure engagement area. At the opposite and opposing end of the twist-off closure opener is the beverage can stay-on tab closure engagement area, which consists of a molded slot at the end of the smaller radius with diameter through. The beverage can stay-on tab opener engagement area is approximately larger than the tab of the beverage can closure and is in the horizontal plane. The closure opener is rotated over so that the beverage can stay-on tab closure slot is nearest the stay-on tab. The user would then slide the stay-on tab closure slot on to the stay-on tab, up to the stay-on tab rivet or as far as possible. The closure opener is then disposed upward, approximately to a forty-five degree angle or until the scored beverage can closure is opened. The user therefore minimizes finger movement and does not utilize the fingernails in any manner to pry the stay-on tab upward. The crimped-on type closure opener, will open both twist-off type and pry-off type closures and is enabled by means of a recessed loop into the first and second edge of the lower surface. The recessed loop concludes with a hooks fashioned in a manner as to bind on the crimped-on closure projections when the closure is placed into the recessed loop and disposed upward it hangs on the projections and lifts the bottle closure off. The present embodiment is of sufficient length to act as a force multiplier or lever, reducing the work necessary to open any of the aforementioned closures. The present embodiment also provides a narrowing body, which is ergonomically, correct fitting the average full palm of the hand and having a substantially flat upper surface, providing a printable surface for printing, when required.

### BRIEF DISCRIPTION OF THE SEVERAL VIEWS OF THE DRAWINGS

FIG. 1 is a perspective top view of the closure opener showing the ergonomically correct handle and the top general form and appearance of the opener. The twist-off closure engagement ribs extending to the top of the diameter through of the largest radius and the smaller radius and diameter through on the opposite end

FIG. 2 is a perspective bottom view of the closure opener of FIG. 1 showing twist-off closure opener locating aid bevel slide, to engagement ribs and engagement ribs. The cored out bottom of closure opener and the crimped-on closure opener, which is a recessed loop, is also shown.

FIG. 3 is a perspective end view of FIG. 1 opposite the twist-off closure engagement area which is the beverage can stay-on tab closure engagement area and the printable flat surface of the closure opener as well as the recessed loop of the crimped-on closure engagement area.

FIG. 4 is a side view of FIG. 1 showing the recessed loop and pry hook of the crimped-on closure opener and the beverage can stay-on tab closure engagement area.

### DETAILED DESCRIPTION OF THE INVENTION

Referring to the drawings, there is shown a multi-purpose beverage container closure opener which is ideally suited for arthritis suffers. It opens and seals plastic twist-off closures, stay-on beverage can tabs and crimped-on (both twist-off and pry-off) bottle closures.

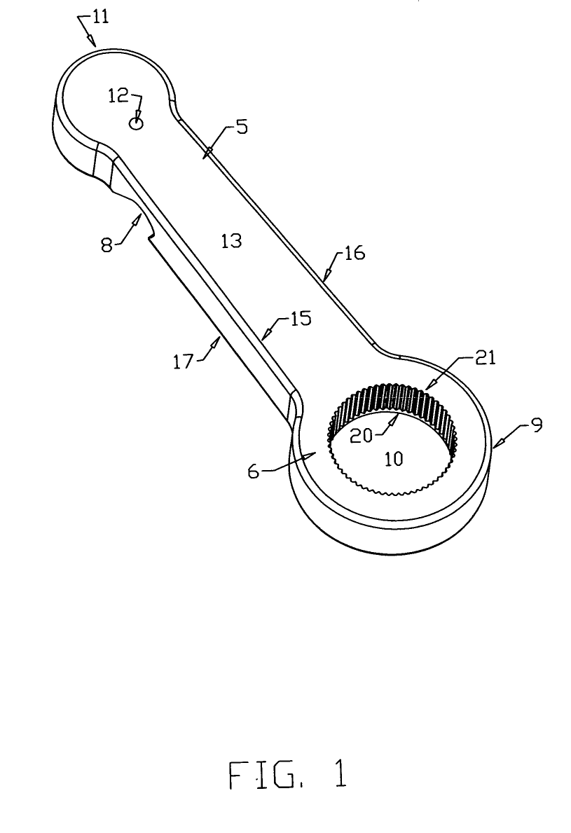

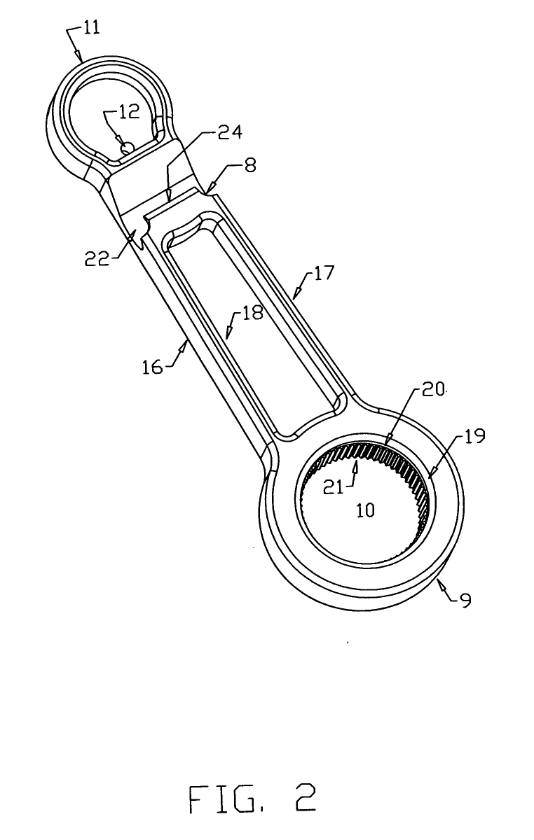

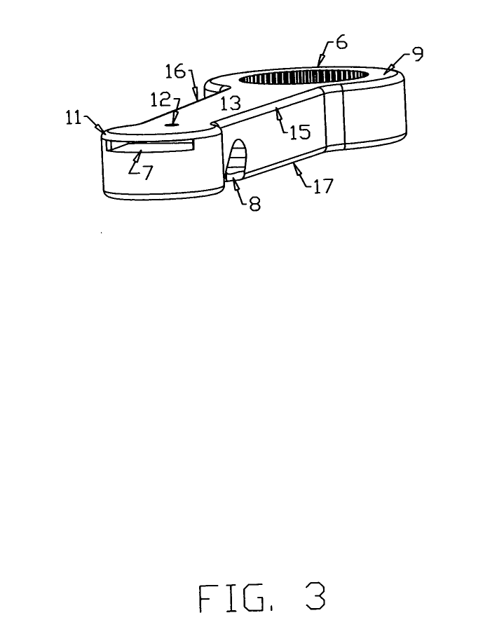

This multi-purpose opener 5 (see FIG. 1) which is elongated, planar and somewhat narrowing is of sufficient length to maximize leverage in both the horizontal and vertical planes, thus minimizing the work necessary to open beverage contain closures. The plastic twist-off cap engagement area 6 (see FIG. 1), beverage can stay-on tab engagement area 7 (see FIGS. 3 & 4), and the crimped-on bottle cap engagement area 8 (see FIGS. 2 & 4) are strategically located to provide comfort and ergonomic assistance to the user.

The multi-purpose opener is a primarily injection-molded polymer designed to provide durability ease of cleaning and to be lightweight. The present embodiment is comprised of two major radiuses 9 and 11 at opposite and opposing ends. The largest radius 9 (see FIG. 1) with diameter through 10, which is the plastic twist-off cap engagement area 6, is formed by three different and distinct inside diameters 19, 20 and 21 (see FIG. 2) all forming parts of the cylindrical interior wall.

The multi-purpose opener has a generally elongated, planer and somewhat narrowing body 5 (see FIG. 1) having the largest radius 9 and diameter through at one end and a smaller radius 11 and diameter through 12 at the opposite and opposing end. An upper surface 13 and a lower surface 14 (see FIG. 2), a first upper edge 15 and a second upper edge 16 opposing the first. A first lower edge 17 (see FIG. 2) and a second lower edge 18 opposing the first, on the lower surface. Referring to FIG. 1, 2 the three different and distinct inside diameters of the plastic twist-off bottle engagement area 6 are comprised of the twist-off closure locating aid 19, slide 20 to engagement ribs and engagement ribs 21. The twist-off closure locating aid 19, which forms the largest inside diameter, consist of a bevel or inward slanting angle molded into the cylindrical interior wall of the plastic twist-off engagement area 6. This feature allows the user to locate the closure in an expeditious manner and channels the closure into the next engagement profile, which is the slide 20 to engagement ribs. The slide 20 to engagement ribs is a ninety degree angle molded above the closure locating aid 19 and allows for the proper positioning of the closure so that the small projections or serrations of twist-off closure are readily accepted by the engagement ribs 21. The slide 20 to engagement ribs form the next or second of the three different and distinct inside diameters of the cylindrical interior wall. The engagement ribs 21, which are above the slide 20, are composed of an array of vertically aligned ribs that continue through to the upper surface of the largest diameter through 10. The vertically aligned ribs 21 engage the small projections or serrations of the twist-off closure and when the closure opener is forced in a counter clockwise rotation, break the seal and loosen the plastic twist-off closure. The engagement ribs 21 form the third and smallest of the three different and distinct inside diameters of the largest diameter through, all of which form parts of the cylindrical interior wall. The plastic twist-off closure engagement area 6 can also be used to reseal plastic twist-off caps when seated and rotated in a clockwise rotation. Thus preserving the beverage for later use.

Referring now to FIG. 3 at the opposite and opposing end of the largest radius 9, and plastic twist-off closure engagement area 6, is the beverage can stay-on tab closure opener 7. The beverage can stay-on tab closure engagement area 7, is a slot molded into the smaller radius 11, of the closure opener, near the upper surface 13. The beverage can stay-on tab closure slot 7, is approximately larger than the stay-on tab of the beverage can. The closure opener 5, is rotated over so that the beverage can stay-on tab closure slot 7, is nearest the stay-on tab. The user would then slide the stay-on tab closure slot 7, on to the stay-on tab, up to the stay-on tab rivet or as far as possible. The closure opener 5, is then disposed upward, approximately to a forty-five degree angle or until the scored beverage can closure is opened. The user therefore minimizes finger movement and does not utilize the fingernails in any manner to pry the stay-on tab upward.

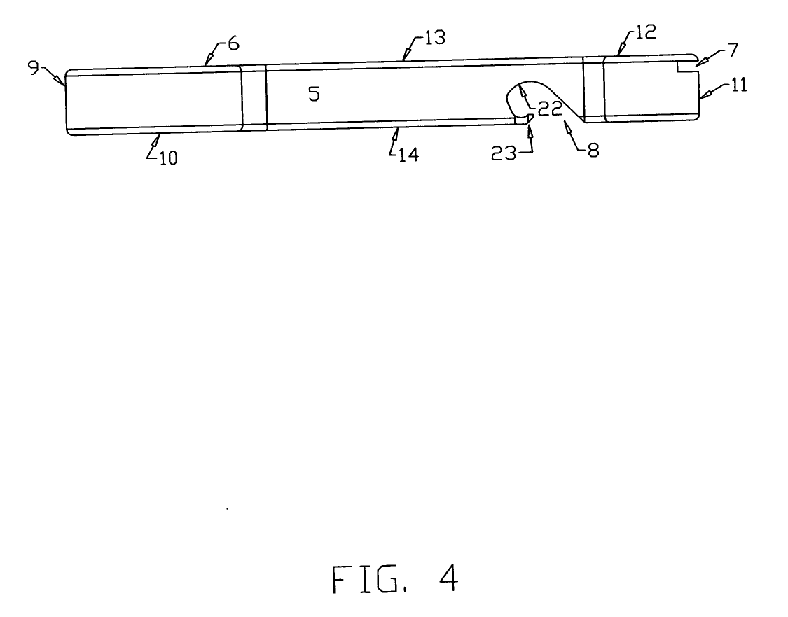

Now Generally illustrated by FIG. 2, 4 the crimped-on beverage bottle closure engagement area 8, which is a molded, recessed loop 22, large enough to receive a crimped-on beverage bottle closure (see FIG. 4). The recessed loop 22, ends in two upward jutting projections or hooks 23, when the closure is seated satisfactorily into the crimped-on closure engagement area 8, the user then disposes the opposite end upward causing the crimped-on beverage bottle closure engagement hooks 23 to catch upon the crimped-on closure projections. When the user continues to dispose the opposite end of the closure opener upward, the closure is pried off. The crimped-on beverage bottle closure opener is suitable for both twist-off and pry-off beverage bottle closures, which are crimped-on.

Alternatively, opener s may be equipped with a molded or metal molded into plastic lip 24, which is briefly shown on FIG. 2 only. The lip 24 is designed to accomplish the same function, engaging the closure for prying off or as earlier described for the removal of crimped-on beverage bottle closures. This alternative is dependent upon types of polymers employed in manufacturing which may increase the openers 5 durability or by any other alternative means that would accomplish the function of crimped-on beverage bottle closure removal and are considered to fall within the intended spirit and scope of the present invention. Both the primary crimped-on closure opener 23, and the alternate 24, are located on the lower edges 17, 18, of the opener 5 and are nearest the end of the smaller radius 11, and smaller diameter through 12.

Also illustrated on FIG. 1,2 is the smaller diameter through 12, opposite the end of the largest radius 9, which serves as an opening or hole with which the closure opener can be placed on a key chain, cord, hook or peg for storage or portability. This diameter through is formed as part of the injection molding process and the closure opener 5 consist of a unitary body with no moving parts.

1. A multi-purpose opener/sealer for opening/sealing plastic twist-off caps, opening crimped-on type beverage closures (both twist-off and pry-off types) and beverage can stay-on tab closures.
A generally elongated, planer, somewhat narrowing body having the largest radius with diameter through at one end and a smaller radius and diameter through at the opposite and opposing end. An upper surface and a lower surface, a first upper edge and a second upper edge opposing the first, on the upper surface. A first lower edge and a second lower edge opposing the first, on the lower surface.

2. A multi-purpose opener/sealer for opening/sealing twist-off caps and opening crimp-type beverage caps and beverage can stay-on tab closures.
A generally elongated, planer, somewhat narrowing body having the largest radius with diameter through at one end and a smaller radius and diameter through at the opposite and opposing end. An upper surface and a lower surface, a first upper edge and a second upper edge opposing the first, on the upper surface. A first lower edge and a second lower edge opposing the first, on the lower surface.
A beverage can tab opener integral and near the upper surface of said smaller radius and diameter through, approximately wider than the beverage can tab, comprised of a molded slot of which when engaged, by sliding the tab into the slot, and then inclining the opposite end of said elongated, planer and somewhat narrowing body, will open the scored closure of said beverage can.

3. A multi-purpose opener/sealer for opening/sealing twist-off caps and opening crimp type beverage caps and beverage can stay-on tab closures.
A generally elongated, planer, somewhat narrowing body having the largest radius with diameter through at one end and a smaller radius and diameter through at the opposite and opposing end. An upper surface and a lower surface, a first upper edge and a second upper edge opposing the first, on the upper surface. A first lower edge and a second lower edge opposing the first, on the lower surface.
A beverage can tab opener integral and near the upper surface of said smaller radius and diameter through, approximately wider than the beverage can tab, comprised of a molded slot of which when engaged by sliding the tab into the slot and then inclining the opposite end of said elongated, planer and somewhat narrowing body, will open the scored closure of said beverage can.
A pry-type beverage bottle opener for opening crimped-on beverage caps, molded into said first edge and said second edge of said lower surface nearest the end of said smaller radius of said diameter through. The pry-type opener is engaged at the lower surface of the bottle cap, by means of a recessed loop to receive the crimped-on bottle cap, which when disposed upward hook the bottle cap serrations or projections lifting the bottle cap away.

4. A multi-purpose opener/sealer for opening/sealing twist-off caps and opening crimp type beverage caps and beverage can stay-on tab closures.
A generally elongated, planer, somewhat narrowing body having the largest radius with diameter through at one end and a smaller radius and diameter through at the opposite and opposing end. An upper surface and a lower surface, a first upper edge and a second upper edge opposing the first, on the upper surface. A first lower edge and a second lower edge opposing the first, on the lower surface.
A beverage can tab opener integral and near the upper surface of said smaller radius and diameter through, approximately wider than the beverage can tab, comprised of a molded slot of which when engaged, by sliding the tab into the slot, and then inclining the opposite end of said elongated, planer and somewhat narrowing body, will open the scored closure of said beverage can.
A pry-type beverage bottle opener for opening crimped-on beverage caps, molded into said first edge and said second edge of said lower surface nearest the end of said smaller radius of said diameter through. The pry-type opener is engaged at the lower surface of the bottle cap, by means of a recessed loop to receive the crimped bottle cap, which when disposed upward hook the bottle cap serrations or projections lifting the bottle cap away.
A twist-off cap engagement area at the end of said largest radius of said elongated body with three different and distinct inside diameters, each forming part of the cylindrical interior wall of the diameter through, beginning at the lower surface all of which are attached and integral of said largest radius of said diameter through of said elongated body.
A twist-off cap locating aid by means of a bevel or inward slanting angle which begins at the lower surface of said largest radius of said diameter through of said elongated body and is the beginning and largest of the three said different and distinct inside diameters, all of which are part of the cylindrical interior wall. The twist-off cap locating aid is angled toward the next smaller inside diameter of said diameter through, all forming part of said cylindrical interior wall of said largest radius of said elongated body.
A twist-off cap slide to engagement ribs, which is directly above and attached to said twist-off cap locating aid and forms part of said cylindrical interior wall of said diameter through of said largest radius of said elongated body. The twist-off cap slide to engagement area, which is in the vertical plane, forms the second and smaller of said three different and distinct inside diameters of said diameter through all of which form part of said cylindrical interior wall of said largest radius of said elongated body. The slide encourages the twist-off bottle cap into proper positioning allowing the engagement ribs to seat on the twist-off cap quickly and precisely.
Twist-off cap engagement ribs, which are directly above and attached to said twist-off cap slide of said cylindrical diameter through and forming part of said interior wall of said diameter through of said largest radius of said elongated body. The twist-off cap engagement ribs are the smallest inside diameter of said three different and distinct inside diameters of said cylindrical diameter through of said largest radius of said elongated body. The engagement ribs are comprised of an array of vertically molded ribs, which project toward and clasp, bind or grip the surface of twist-off caps when seated and then forced in a counter clockwise rotation. The twist-off cap engagement ribs have an approximately larger inside diameter than the outside diameter of the twist-off cap, but not so large as to allow the twist-off cap to slip completely through. The array of vertically aligned ribs are equally spaced and continue to the upper surface of said inside diameter through of said largest radius of said elongated body and forms the third and smallest inside diameter of the three different and distinct inside diameters, all forming part of said cylindrical interior wall of said diameter through of said largest radius of said elongated body.
A handle that is wider at the end of said largest radius with diameter through and narrows at the opposite and opposing end having said smaller radius and said diameter through of said elongated body. A radius placed at each corner and running parallel nearly the full length of the narrowing somewhat rectangular portion of said elongated body offers a comfortable grip. Between the first and second edge of said upper surface is flat, smooth and printable, if warranted. The lower surface between said first edge and said second edge is cored out, somewhat hollow for weight reduction and to minimize plastic shrinkage after molding. The said cored out, somewhat hollow section runs parallel to said lower surface and ends near the said diameter through of largest radius and the molding of the crimp-on type opener of said elongated body. The lower surface of said smaller radius of said diameter through is also cored out for weight reduction and to minimize plastic shrinkage after molding. The handle which is primarily between said smaller radius of said diameter through and largest radius of said diameter through is of sufficient length to act as a force multiplier or lever thereby minimizing the strength required by the user to open the twist-off caps, crimp type lids or lift up tabs. The handle length between said smaller diameter through of said smaller radius and said diameter through of said largest radius, takes advantage of arm and shoulder strength and minimize the need for finger and hand strength. At the ends of said handle, attached and integral to, are a large radius with said diameter through and at the said opposite and opposing end a smaller radius with a diameter through, both of which are primarily beverage container lid engagement areas, but secondly serves to disallow the user's hand from slipping off said elongated body when in use. The said elongated, planar somewhat narrowing body allows the user to open twist-off caps when rotated in a counter clockwise direction and to reseal twist-off caps tightly when rotated in a clockwise direction.

5. The opener of claim 4 is provided with a small diameter through at or near the end of said smaller radius fashioned to accept a peg, hook, string, key chain, etc. for storage or portability.
